(19) United States
(12) Patent Application Publication
(10) Pub. No.: US 2006/0236128 A1
(43) Pub. Date: Oct. 19, 2006

(54) Method for authentication of electronic components

(76) Inventor: Christian Christiansen, Chesterfield, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/098,164

(22) Filed: Apr. 4, 2005

(51) Int. Cl. G06F 12/14

(52) U.S. Cl. 713/193

(57) ABSTRACT

A method for authentication of an electronic component requires the initial step of operatively coupling the electronic component to a processing system configured to communicate with the electronic component and to receive data there from. Subsequent to the operative coupling, an electronic representation of a proprietary work of authorship stored in the electronic component is communicated to the processing system and compared with a second representation of the proprietary work of authorship previously stored in the processing system. In the event the communicated proprietary work of authorship and the previously stored representation of the work of authorship deviate from each other, authentication of the electronic component is denied by the processing system.

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention is related generally to methods for authentication of electronic components, such as consumable electronic components utilized in combination with a non-consumable electronic device, and more particularly, towards a method for authentication of consumable electrode arrays utilized in combination with a bioelectric signal measurement and processing system.

A variety of electronic measurement and processing systems utilize consumable electronic components as one-time or limited-use removable sensors which are operatively coupled to the electronic measurement and processing system as required. For example, electronic measurement and processing systems used in medical applications, such as electroencephalograph or electrocardiograph measurement system, are configured with electrode arrays which are usually disposed of and replaced after use with a single patient, avoiding the need for sterilization and the risk of disease transmission. Additionally, many electrode arrays utilized in medical applications include an electrically conductive gel to improve electrical contact with a patient's skin, which can become depleted by multiple uses of the electrode array.

To ensure proper operation of the electronic measurement and processing system, it is necessary to utilize the consumable electronic components having the proper electrical properties and manufacturing tolerances. Additionally, it is necessary to ensure that individual consumable electronic components are not utilized after their intended expiration or number of uses.

It is known to configured electronic measurement and processing systems with proprietary couplings to ensure that only consumable electronic components having a matching coupling may be utilized with the electronic measurement and processing systems. While this ensures that consumable electronic components having mis-matched couplings will not be used with the electronic measurement and processing system, it does not provide a method for authenticating that a consumable electronic component configured with the proprietary coupling is, in-fact, intended for use with the electronic measurement and processing system, and does not provide a manufacturer of the consumable electronic components with an identification of the source of the consumable electronic components.

One known method for providing authentication of a consumable electronic component requires a data storage device, such as a microchip or logic circuit, to be incorporated into the consumable electronic component. Information contained in the data storage device may include permanent data such as unique serial number, access code, or manufacturer identification code, as well as variable data such as the number of times the component has been used, the length of time the component has been in use, and a data of expiration for the consumable electronic component. When the consumable electronic component is coupled to the electronic measurement and processing system, the information contained in the data storage device is accessed by the electronic measurement and processing system, and evaluated to determine the authenticity and usability of the consumable electronic component. However, copying of the stored data by a third party manufacturer may be unrestricted, enabling the manufacture of third party consumable electronic components for use with the electronic measurement and processing system.

Accordingly, it would be advantageous to provide a method of authentication of a consumable electronic component for an electronic measurement and processing system which relies upon the storage and communication of a proprietary work of authorship between the consumable electronic component and the electronic measurement and processing system, thereby exposing a third party manufacturer of an unauthorized consumable electronic component to liability under enforceable copyright laws.

### BRIEF SUMMARY OF THE INVENTION

Briefly stated, a method of the present invention provides for authentication of an electronic component. The method requires the initial step of operatively coupling the electronic component to a processing system configured to communicate with the electronic component and to receive data there from. Subsequent to the operative coupling, an authentication request is communicated from the processing system to the electronic component. Responsive to the authentication request, an electronic representation of a proprietary work of authorship stored in the electronic component is communicated to the processing system and compared with a second representation of the proprietary work of authorship previously stored in the processing system. In the event the communicated proprietary work of authorship and the previously stored representation of the work of authorship deviate from each other, authentication of the electronic component is denied by the processing system.

An additional method of the present invention provides for authentication of an electronic component. The method requires the initial step of operatively coupling the electronic component to a processing system configured to communicate with the electronic component and to receive data there from. Subsequent to the operative coupling, an authentication request is communicated from the processing system to the electronic component. Responsive to the authentication request, an electronic representation of a proprietary work of authorship stored in the electronic component is communicated to the processing system and compared with a second representation of the proprietary work of authorship previously stored in the processing system. In the event the communicated proprietary work of authorship and the previously stored representation of the work of authorship match, the electronic component is authenticated, and a new predetermined proprietary work of authorship is transferred from the processing system to the electronic component for storage therein. The new predetermined proprietary work of authorship is deemed to be representative of a “use” of the electronic component by the processing system.

The foregoing and other objects, features, and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a flow chart illustrating a method of the present invention for the authentication of an electronic component;

FIG. 2 is a flow chart illustrating an alternate method of the present invention for the authentication and use tracking of an electronic component.

Corresponding reference numerals indicate corresponding parts throughout the several figures of the drawings.

### DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

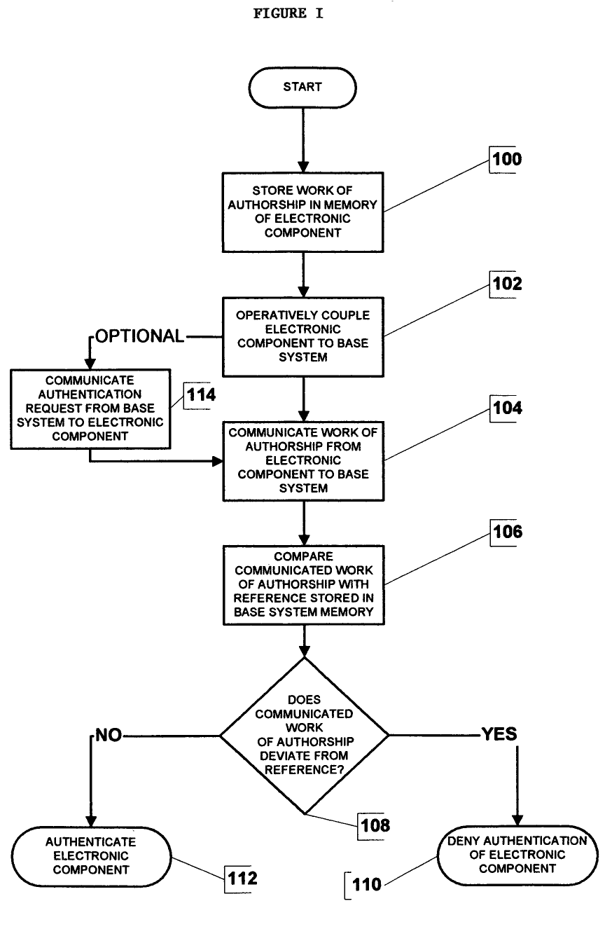

In a first embodiment, illustrated in FIG. 1, a method of the present invention provides for authentication of a electronic component, such as a consumable electrode array, by communicating authentication information including a proprietary work of authorship protected under national copyright laws to a processor associated with a system to which the consumable electronic component is operatively coupled. Initially, authentication data comprising a work of authorship, such as a literary work, musical work, pictorial work, graphical work, or sound recording is stored in a memory associated with the electronic component (Box 100). During use, the electronic component is operatively coupled to a base system, (Box 102) such as an electronic measurement and processing system, which includes a processor configured to communicate with the electronic component and to receive data there from. The authentication data stored in the memory associated with the electronic component is communicated from the electronic component to the processor of the base system (Box 104).

Once the authentication data is received by the processor of the base system, the processor of the base system compares the received authentication data with reference data stored in a memory of the base system (Box 106). The reference data stored in the memory of the base system preferably includes a second representation of the proprietary work of authorship. In the event the communicated authentication data and the previously stored representation of the work of authorship deviate from each other, (Box 108), authentication of the electronic component is denied (Box 110) by the processor of the base system. If the evaluation indicates that the authentication data, i.e. the work of authorship, does not deviate from the reference data, the electronic component is authentication as valid for use with the base system (Box 112).

Optionally, once the electronic component is operatively coupled to the base system (Box 102), an authentication request is communicated from the base system to the electronic component (Box 114). Responsive to the authentication request, the authentication data, i.e. the work of authorship, is communicated from the electronic component to the base system (Box 104).

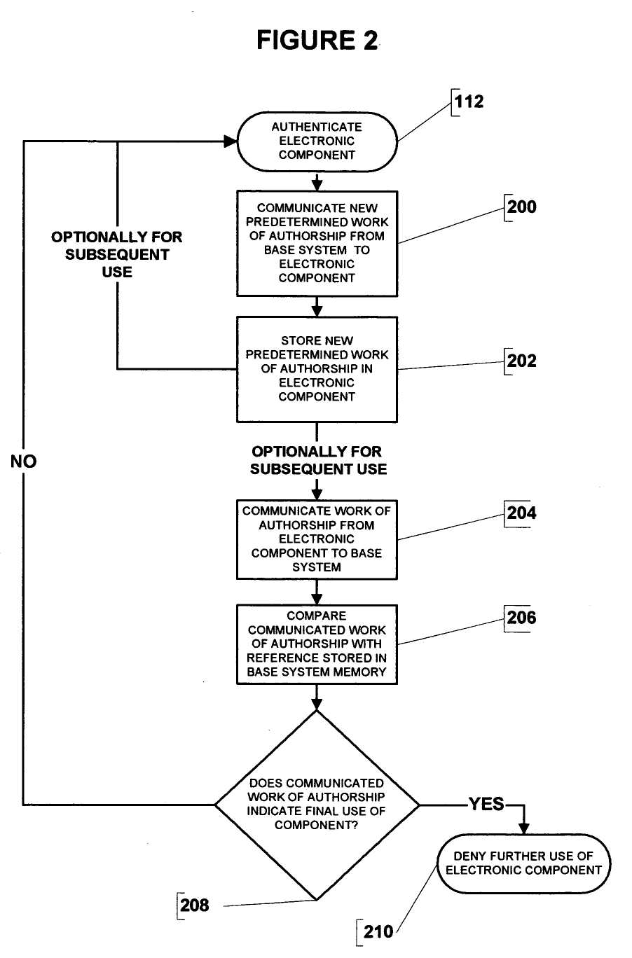

Turning to FIG. 2, an additional method of the present invention provides for the ability to determine if a electronic component has been used by an authorized user, and optionally, if the electronic component has reached the end of a predetermined operational life. Once the electronic component is authenticated (Box 112) for use, as previously described, a new proprietary work of authorship protected under national copyright laws is communicated from the processor associated with the base system to the consumable electronic component (Box 200). The new proprietary work of authorship is then stored in the electronic component (Box 202), The new proprietary work of authorship may either replace the work previously stored in the electronic component, or may be stored therein in addition to any previously stored works of authorship.

Optionally, upon the next use and/or authentication of the electronic component (Box 112), the new proprietary work of authorship stored in the electronic component is communicated to the processor of the base system for comparison and authentication. By utilizing predetermined proprietary works of authorship, the processor of the base system is configured to identify that the electronic component has been previously used at least once. The steps of storing a new proprietary work of authorship in the electronic component and retrieving it there from, (Box 204) can then be repeated for a predetermined number of use/authentication cycles, enabling the processor to track the number of times an electronic component has been used, based a comparison of the particular work of authorship stored therein with a predetermined sequence of works of authorship (Box 206).

Optionally, the processing system can be configured to compare the work of authorship retrieved from the electronic component with a predetermined work of authorship which is indicative of a final use for the electronic component, i.e. the end of the operational lifespan of the electronic component (Box 208). If a match is identified, the processor is configured to deny further use of the electronic component (Box 210), ensuring that electronic components, such as electrodes, which have a limited life span or usage, are not utilized beyond their predetermined operational life span.

Those of ordinary skill in the art will recognize that in order for an unauthorized third party manufacturer to produce an electronic component which can be authenticated by a base system using the method of the present invention, it will be necessary for the unauthorized third party manufacturer to duplicate the authentication data stored in the memory of the electronic component. By utilizing authentication data which consists of a work of authorship, unauthorized duplication of the authentication data, as is required for the manufacture of an electronic component capable of authentication with a base system using the method of the present invention, will provide an authorized manufacturer with legal recourse against the unauthorized third party manufacture as associated with national copyright laws.

The present invention can be embodied in-part in the form of computer-implemented processes and apparatuses for practicing those processes. The present invention can also be embodied in-part in the form of computer program code containing instructions embodied in tangible media, such as floppy diskettes, CD-ROMs, hard drives, or an other computer readable storage medium, wherein, when the computer program code is loaded into, and executed by, an electronic device such as a computer, micro-processor or logic circuit, the device becomes an apparatus for practicing the invention.

The present invention can also be embodied in-part in the form of computer program code, for example, whether stored in a storage medium,. loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented in a general-purpose microprocessor, the computer program code segments configure the microprocessor to create specific logic circuits.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. A method for authentication of an electronic component for use with a processing system, comprising:
operatively coupling the electronic component to the processing system for data communication;
communicating an electronic representation of a proprietary work of authorship associated with the electronic component from a data storage associated with the electronic component to the processing system;
comparing said communicated electronic representation with a previously stored electronic representation of said proprietary work of authorship associated with the processing system; and
responsive to said comparison indicative of a difference between said communicated electronic representation and said previously stored electronic representation, denying authentication of the electronic component.

2. The method of claim 1 further including the step of communicating an authentication request from the processing system to the electronic component, and wherein said step of communicating an electronic representation of a proprietary work of authorship is responsive to said authentication request.

3. The method of claim 1 further wherein responsive to said comparison indicated of a match between said communicated electronic representation and said previously stored electronic representation, authenticating the electronic component for use with the processing system.

4. The method of claim 3 further including the step of communicating an electronic representation of a second proprietary work of authorship from the processing system to the electronic component; and
storing said electronic representation of said second proprietary work of authorship in said data storage associated with the electronic component; and
wherein said second proprietary work of authorship is representative of a use of the electronic component.

5. The method of claim 3 further including the step of communicating an electronic representation of a second proprietary work of authorship from the processing system to the electronic component; and
replacing said electronic representation of said proprietary work of authorship stored in said data storage associated with the electronic component with said electronic representation of said second proprietary work of authorship; and
wherein said second proprietary work of authorship is representative of a use of the electronic component.

6. The method of claim 1 wherein responsive to said comparison indicative of a match between said communicated electronic representation and said previously stored electronic representation, providing an indication of previous use of the electronic component.

7. The method of claim 1 wherein responsive to said comparison indicative of a match between said communicated electronic representation and said previously stored electronic representation, providing an indication of expiration of the electronic component.
